(19) United States
(12) Patent Application Publication
(10) Pub. No.: US 2019/0386420 A1
(43) Pub. Date: Dec. 19, 2019

(54) Coaxial Cable Protector

(71) Applicant: Monty McDonald, San Antonio, TX (US)

(72) Inventor: Monty McDonald, San Antonio, TX (US)

(21) Appl. No.: 16/176,739

(22) Filed: Oct. 31, 2018

Related U.S. Application Data
(60) Provisional application No. 62/763,443, filed on Jun. 18, 2018.

(51) Int. Cl. H01R 13/447; H02G 3/08; H02G 3/14; H01R 13/73; H01R 24/40; H02G 15/02

(52) U.S. Cl. CPC H01R 13/447; H02G 3/083; H02G 15/025; H01R 13/73; H01R 24/40; H02G 3/14

(57) ABSTRACT

A coaxial cable protector and method of customizing a coaxial cable protector which redirect the angle at which the cable protrudes from the wall plate cover to minimize interference with furniture and electronics. The coaxial cable protector having at least one cable aperture on at least one side panel, at an angle perpendicular the corresponding wall. The coaxial cable further having preselected thin sections of side panel that can be removed by the user to customize the number and location of cable apertures.

### CROSS-REFERENCES TO RELATED APPLICATIONS

This application claims priority to U.S. provisional application No. 62/763,443.

### STATEMENT REGARDING FEDERALLY SPONSORED RESEARCH OR DEVELOPMENT

Not applicable.

### BACKGROUND OF THE INVENTION

### 1. Field of the Invention

The present invention relates to a coaxial cable protector for concealing the ingress and/or egress of cables or cords through a wall or similar barrier. More specifically, the invention relates to a wall plate cover for ingress and/or egress of coaxial and/or other cables through the wall of a house or similar structure.

### 2. Description of the Related Art.

Wall plate covers for coaxial cables are generally known in the art. However, prior art coaxial cable wall plate covers are problematic because the coaxial cable protrudes through a hole on the outer surface of the wall plate cover at a ninety degree angle relative to the vertical plane of the outer surface of the wall plate cover. The ninety degree protrusion angle causes the coaxial cable to stick out from the wall several inches. The protrusion makes it difficult for furniture or electronics to be pressed flush against the wall plate cover and, correspondingly, the wall. The protrusion of the coaxial cable results an unsightly gap between furniture and walls, and/or the coaxial cable being bent and damaged when furniture is pushed against a wall. The contact between the protruding cable and furniture/electronics can also damage the furniture/electronics.

### BRIEF SUMMARY OF THE INVENTION

The present invention is a wall plate cover with an outer surface and four side surfaces, wherein an aperture for egress and ingress of cables or similar material is located on a side surface of the wall plate cover.

In one embodiment of the present invention, preselected sections on each side surface of the wall plate cover are significantly thinner than the rest of the wall plate cover. The preselected thin sections allow the user to easily remove one or more preselected sections and customize the location(s) of apertures for the ingress and egress of cables.

### BRIEF DESCRIPTION OF THE SEVERAL VIEWS OF THE DRAWINGS

FIG. 1 is a front view of a prior art coaxial cable wall plate cover.

FIG. 2 is a back perspective view of a first embodiment of the coaxial cable protector.

FIG. 3 is a front perspective view of a first embodiment of the coaxial cable protector.

FIG. 4 is a back perspective view of a second embodiment of the coaxial cable protector.

FIG. 5 is a back perspective view of a second embodiment of the coaxial cable protector.

FIG. 6 is a front perspective view of a second embodiment of the coaxial cable protector.

### DETAILED DESCRIPTION OF THE INVENTION

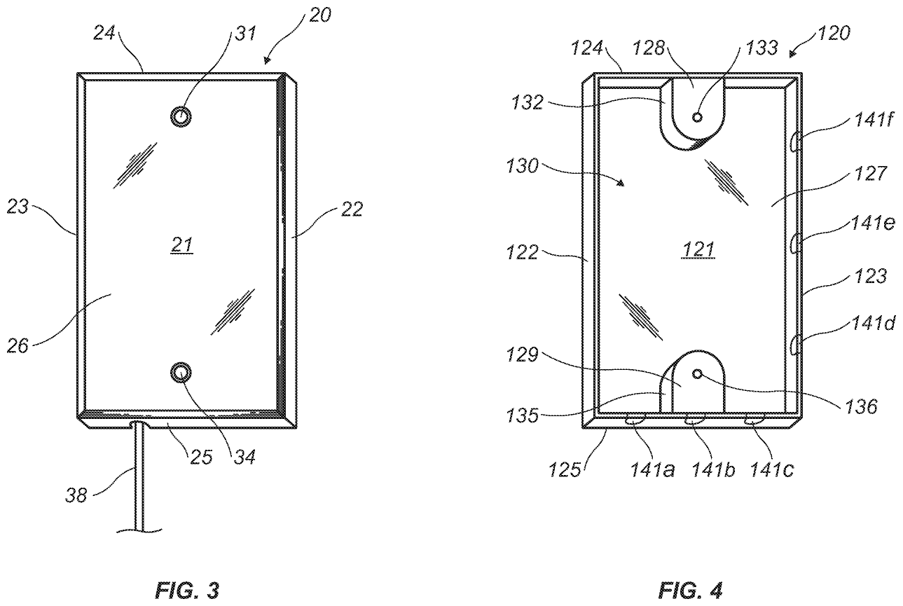

The structure of a first embodiment of the wall plate cover 20 is described with reference to FIGS. 2 and 3. The wall plate cover 20 comprises a rectangular cover panel 21 with a first surface 26 and a second surface 27. The wall plate cover 20 further comprises a first side panel 22, a second side panel 23, a third side panel 24, and a fourth side panel 25. One edge of each side panel 22, 23, 24, 25 is integral the second surface 27 of the cover panel 21. The side panels 22, 23, 24, 25 and the second surface 27 of the cover panel 21 form a cavity 30.

The first embodiment 20 of the wall plate cover comprises a first mounting assembly 28 and a second mounting assembly 29. The first mounting assembly 28 is integral the second surface 27 of the cover panel 21 and the third side panel 24. The first mounting assembly 28 is located on the central axis of the wall plate cover 20 in the cavity 30. The second mounting assembly 29 is integral the second surface 27 of the cover panel 21 and the fourth side panel 25. The second mounting assembly 29 is located on the central axis of the wall plate cover 20 in the cavity 30.

The first mounting assembly 28 comprises a first screw hole 31, a screw guide 32, a second screw hole 33, and a screw (not shown). The second mounting assembly 29 comprises a first screw hole 34, a screw guide 35, a second screw hole 36, and a screw (not shown). The first screw holes 31, 34 are integral the first surface 26 of the cover panel 21.

The wall plate cover 20 further comprises a cable aperture 37 integral the fourth side panel 25. The cable aperture 37 in the first embodiment 20 is a semi-circular cut-out in the edge of the fourth side panel 25 distal the cover panel 21. The plane of the cable aperture 37 is perpendicular to the plane of the cover panel 21. A cable 38 can egress and/or ingress the wall plate cover 20 via the cable aperture 37.

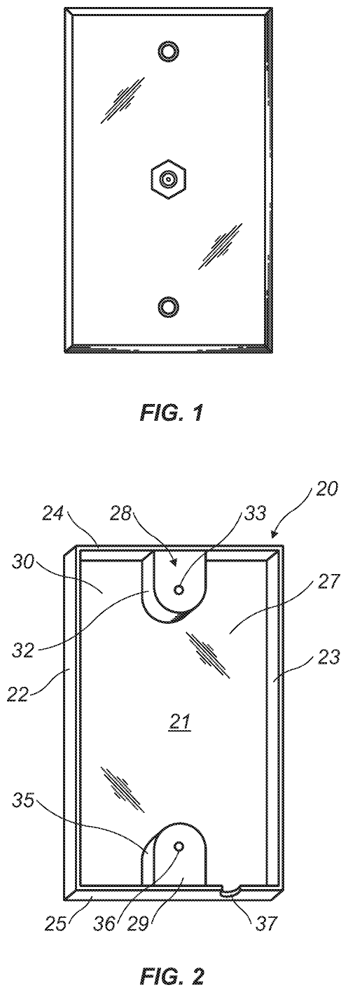

The function of the wall plate cover 20 is described with reference to FIGS. 1-3. The wall plate cover 20 is used to cover a hole in a wall or similar surface. The wall plate cover 20 is specifically designed to cover holes in which a cable(s) 38 (phone, coaxial, ethernet etc.) needs to egress or ingress a wall.

The side panels 22, 23, 24, 25 are placed flush against the wall and situated so that the hole and protruding cable 38 are covered. The cavity 30 provides room, if necessary, for excess cable 38 and/or bends or kinks in the cable 38. The cable 38 is directed through the cable aperture 37 in the fourth side panel 25.

The wall plate cover 20 is secured to the wall using the first and second mounting assemblies 28, 29. The screws are inserted through the first screw holes 31, 34, through the screw guides 32, 35, though the second screw holes 33, 36 and secured to the wall.

When secured, the side panels 22, 23, 24, 25 of the wall plate cover 20 are flush against the wall. The first surface 26 of the cover panel 21 is the furthest point of the wall plate cover 20 from the wall. The cable 38 exits the wall plate cover 20 at an angle substantially parallel to the plane of the first panel 21. The vertical plane the cable 38 is closer to the wall than the vertical plane of the cover panel 21.

The structure of a second embodiment of embodiment of the wall plate cover 120 is described with reference to FIGS. 4 and 5. The wall plate cover 120 comprises a rectangular cover panel 121 with a first surface 126 and a second surface 127. The wall plate cover 120 further comprises a first side panel 122, a second side panel 123, a third side panel 124, and a fourth side panel 125. One edge of each side panel 122, 123, 124, 125 is integral the second surface 127 of the cover panel 121. The side panels 122, 123, 124, 125 and the second surface 127 of the cover panel 121 form a cavity 130.

The second embodiment 120 of the wall plate cover comprises a first mounting assembly 128 and a second mounting assembly 129. The first mounting assembly 128 is integral the second surface 127 of the cover panel 121 and the third side panel 124. The first mounting assembly 128 is located on the central axis of the wall plate cover 120 in the cavity 130. The second mounting assembly 129 is integral the second surface 127 of the cover panel 121 and the fourth side panel 125. The second mounting assembly 129 is located on the central axis of the wall plate cover 120 in the cavity 130.

The first mounting assembly 128 comprises a first screw hole 131, a screw guide 132, a second screw hole 133, and a screw (not shown). The second mounting assembly 129 comprises a first screw hole 134, a screw guide 135, a second screw hole 136, and a screw 140 (not shown). The first screw holes 131, 134 are integral the first surface 126 of the cover panel 121.

The wall plate cover 120 further comprises at least one aperture section 141. The aperture sections 141 in the second embodiment 120 are semi-circular sections integral the second side panel 123 and fourth side panel 125. The aperture sections 141 are sections of side panel significantly thinner than the rest of the wall plate cover 120. The aperture sections 141 are located on the edge of the side panel distal the cover panel 121. The second embodiment 120 is being described with three aperture sections 141 on each side panel 123 and 125. Different locations and numbers aperture of sections are expected.

The function of the wall plate cover 120 is described with reference to FIGS. 4-6. The wall plate cover 120 is used to cover a hole in a wall or similar surface. The wall plate cover 120 is specifically designed to cover holes in which a cable(s) 138 (phone, coaxial, ethernet etc.) needs to egress or ingress a wall.

Before attaching the wall plate cover 121 to the wall, the user determines how many cable apertures are desired, and the desired location for the cable apertures. The user then takes a screw driver (or similar tool) and applies force on the aperture sections 141 corresponding to the desired number and location of cable apertures. The thinness of the aperture sections 141 allows the force applied by the user to easily and neatly remove the desired aperture sections 141. Aperture sections 141 not removed by the user remain integral the respective side panel(s). The aperture sections 141 removed by the user are discarded. The removed aperture sections 141 result in cable apertures 142.

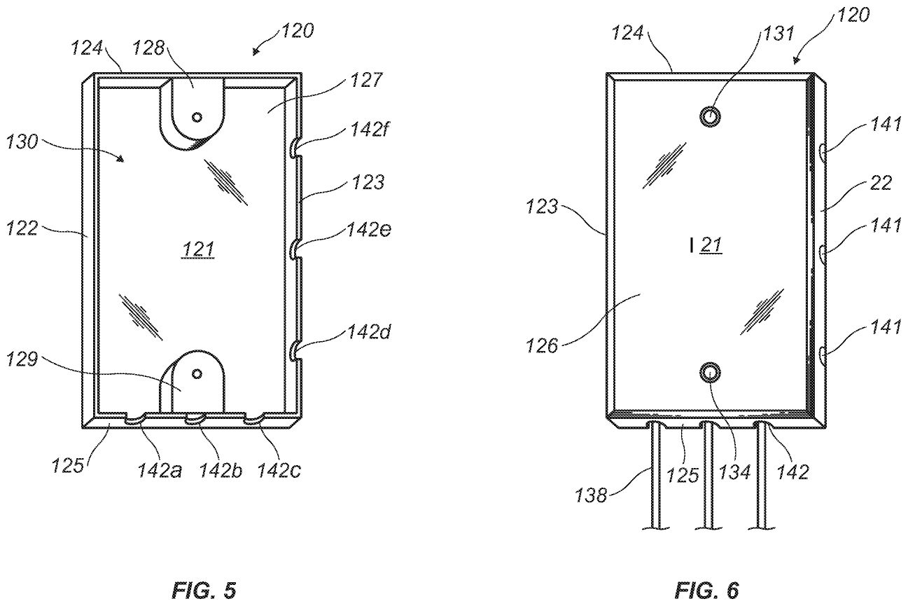

Referring to FIG. 6, Once the user has created the desired combination of aperture sections 141 and cable apertures 142, the wall plate cover 120 is secured to a wall. The side panels 122, 123, 124, 125 are placed flush against the wall and situated so that the hole and protruding cable(s) 138 are covered. The cavity 130 provides room, if necessary, for excess cable(s) 138 and/or bends or kinks in the cable(s) 138. The cable(s) 138 are directed through the cable aperture(s) 142 and out of the wall plate cover 120.

The wall plate cover 120 is secured to the wall using the first and second mounting assemblies 128, 129. Screws are inserted through the first screw holes 131, 134, through the screw guides 132, 135, though the second screw holes 133, 136 and secured to the wall.

When secured, the side panels 122, 123, 124, 125 of the wall plate cover 120 are flush against the wall. Apertures sections 141 that were not removed by the user are also flush against the wall, leaving no gap between the wall plate cover 120 and the wall. The first surface 126 of the cover panel 121 is the furthest point of the wall plate cover 120 from the wall. The cable(s) 138 exits the wall plate cover 120 at an angle substantially parallel to the plane of the first panel 121. The vertical plane the cable(s) 138 is closer to the wall than the vertical plane of the cover panel 121.

1. A wall plate cover comprising:
a cover panel with a first surface and a second surface, and four side panels wherein said side panels are integral the second surface of the cover panel;
an aperture in one of said side panels.

2. The wall plate cover of claim 1, wherein said cover panel is rectangular and said side panels are integral the second surface of the cover panel at ninety degree angles.

3. The wall plate cover of claim 2, wherein said second surface of the cover panel and four side panels form a cavity.

4. A wall plate cover comprising:
a cover panel with a first and second surface, and four side panels wherein said side panels are integral the second surface of the cover panel;
wherein at least one preselected section of said side panels is thinner than the remainder of the cover panel;
wherein said thin section is removable by the user to create a aperture in said side panel.

5. A method of covering the ingress and egress of cables through a hole in a wall using a wall plate cover having a cover panel with a first and second surface and four side panels wherein preselected section of said side panels are thinner than the remainder of the cover panel comprising the steps of:
selecting the number and location of preselected thin sections on said side panels corresponding to the number and size of cables;
applying force to the desired preselected thin section of side panel to create apertures in the side panel.
